(19) United States
(12) Patent Application Publication
(10) Pub. No.: US 2026/0194848 A1
(43) Pub. Date: Jul. 9, 2026

(54) IMAGE FORMING APPARATUS, IMAGE FORMING SYSTEM, ABNORMALITY DETECTION METHOD, AND NON-TRANSITORY RECORDING MEDIUM

(71) Applicant: Shuichi HONDA, Miyagi (JP)

(72) Inventor: Shuichi HONDA, Miyagi (JP)

(73) Assignee: ETRIA Co., Ltd., Kanagawa (JP)

(21) Appl. No.: 19/405,976

(22) Filed: Dec. 2, 2025

(30) Foreign Application Priority Data
Jan. 7, 2025 (JP) 2025-002096

(51) Int. Cl. G03G 15/00; H04N 1/00

(52) U.S. Cl. CPC G03G 15/55; G03G 15/5016; G03G 15/5079; G03G 15/6552; G03G 15/80; H04N 1/00037; H04N 1/00061; H04N 1/00079

(57) ABSTRACT

An image forming apparatus includes a photoconductor, a charger to charge a surface of the photoconductor, a current detector to detect a charging current that flows when the photoconductor is charged, and circuitry. The circuitry outputs a determination result of a condition of the photoconductor obtained using a machine learning model having learned a relationship between the charging current and the condition of the photoconductor.

### CROSS-REFERENCE TO RELATED APPLICATIONS

This patent application is based on and claims priority pursuant to 35 U.S.C. § 119(a) to Japanese Patent Application No. 2025-002096, filed on Jan. 7, 2025, in the Japan Patent Office, the entire disclosure of which is hereby incorporated by reference herein.

### BACKGROUND

### Technical Field

The present disclosure relates to an image forming apparatus, an image forming system, an abnormality detection method, and a non-transitory recording medium.

### Related Art

There are techniques for detecting an abnormality of an image forming member. For example, an image forming apparatus includes an image bearer on which an electrostatic latent image is formed, a charging device that charges the image bearer, a developing device that develops the electrostatic latent image on the image bearer to form a toner image, a developing power supply that applies a predetermined developing bias to the developing device, an exposure device that irradiates the image bearer with light, and a determination unit that determines an abnormality of the image bearer, the charging device, the developing device, or the exposure device.

### SUMMARY

The present disclosure described herein provides an image forming apparatus including a photoconductor, a charger to charge a surface of the photoconductor, a current detector to detect a charging current that flows when the photoconductor is charged, and circuitry. The circuitry outputs a determination result of a condition of the photoconductor obtained using a machine learning model, having learned a relationship between the charging current and the condition of the photoconductor.

The present disclosure described herein provides an image forming system including the image forming apparatus described above, and an information processing apparatus including a memory that stores the machine learning model, and processing circuitry. The circuitry of the image forming apparatus transmits a detection result of the charging current to the information processing apparatus via a network. The processing circuitry of the information processing apparatus inputs the detection result of the charging current to the machine learning model to obtain the determination result of the condition, and the circuitry of the image forming apparatus receives the determination result of the condition from the information processing apparatus.

The present disclosure described herein provides an abnormality detection method including detecting a charging current that flows when a photoconductor is charged, and determining a condition of the photoconductor using a machine learning model having learned a relationship between the charging current and the condition of the photoconductor.

The present disclosure described herein provides a non-transitory recording medium storing a plurality of program codes which, when executed by one or more processors, causes the one or more processors to perform a method. The method including detecting a charging current that flows when a photoconductor is charged, and determining a condition of the photoconductor using a machine learning model having learned a relationship between the charging current and the condition of the photoconductor.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic block diagram of an image forming system;

FIG. 2 is a block diagram illustrating a hardware configuration of an image forming apparatus;

FIG. 3 is a block diagram illustrating a hardware configuration of a machine learning apparatus;

FIG. 4 is a block diagram illustrating a functional configuration of an image forming system;

FIG. 5 is another block diagram illustrating a functional configuration of another image forming system;

FIG. 6 is a diagram illustrating a machine learning model;

FIG. 7 is a diagram illustrating a learning process;

FIG. 8 is a flowchart of an abnormality detection process;

FIG. 9 is a flowchart of another abnormality detection process;

FIGS. 10A to 10C are diagrams illustrating a charging current detected in normal operation;

FIGS. 11A to 11C are diagrams illustrating a charging current detected when a photoconductor surface has a flaw;

FIGS. 12A to 12C are diagrams illustrating a charging current detected when a photoconductor surface has a ripple; and

FIG. 13 is a diagram illustrating a configuration of an image forming apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise. In the drawings, an identical or similar reference numeral designates a component having identical or similar function, and redundant descriptions are omitted in the following description.

The present disclosure provides an information processing system including an image forming apparatus that forms an image on an image forming medium (a recording medium). An information processing system including an image forming apparatus may be referred to as an “image forming system” in the following description. According to one aspect of the present disclosure, the image forming system has an abnormality detection function of detecting an abnormality of the image forming apparatus.

In the description below, when detecting an abnormality in an image forming apparatus, the condition of a photoconductor is determined (inferred) based on the detection result of the charging current that flows when the photoconductor is charged. Specifically, the condition of the photoconductor is determined using machine learning having the following features.

1. A machine learning model is generated using detection results of charging current and information indicating the conditions of a photoconductor as training data. The machine learning model that has been trained is stored in the image forming apparatus or an information processing apparatus external to the image forming apparatus. The external information processing apparatus may be a server with which the image forming apparatus communicates via a communication network, or a cloud computing service.

In the stage of evaluating the design of the image forming system, multiple photoconductors are used to collect the detection results of charging current and image data obtained by reading the images formed on image forming media, and a machine learning model is generated in advance using such data as training data. When the condition of the photoconductor is abnormal, the value of the charging current changes in the circumferential direction. Accordingly, a machine learning model that determines whether the condition of the photoconductor is abnormal can be generated based on the relationship between changes in the charging current and an image defect (which may also be referred to as a defective image, an abnormal image, or the like). Further, for example, when information on changes in the film thickness of the photoconductor or the type of substances adhering to the surface of the photoconductor, surrounding environment information such as temperature or humidity, and image data obtained by reading the formed image are used as training data, a machine learning model that determines the condition of the photoconductor can be generated. In other words, the use of the charging current when the photoconductor is charged enables accurate determination of the condition of the photoconductor, which causes the image defect, and accordingly enables the detection of the sign of the occurrence of image defects.

2. The charging current value detected by the image forming apparatus is input to the trained machine learning model.

The machine learning model determines the condition of the photoconductor based on the learned data. The charging current value is an example of the detection result of the charging current.

When a user uses the image forming apparatus for image formation, the charging current value detected during the image formation is input to the machine learning model, the determination result of the condition of the photoconductor is obtained, and a sign of the occurrence of an image defect is detected. In the related art, it is proposed to calculate the characteristics, such as the eccentricity or the film thickness, of the photoconductor using the charging current value and determine the lifetime. However, detecting the sign of the occurrence of image defects using the charging current value as training data is not proposed. One of the features of the present disclosure is the use of the charging current flowing when the photoconductor is charged as the training data for detecting the sign of occurrence of image defects.

### Overall Configuration of Image Forming System

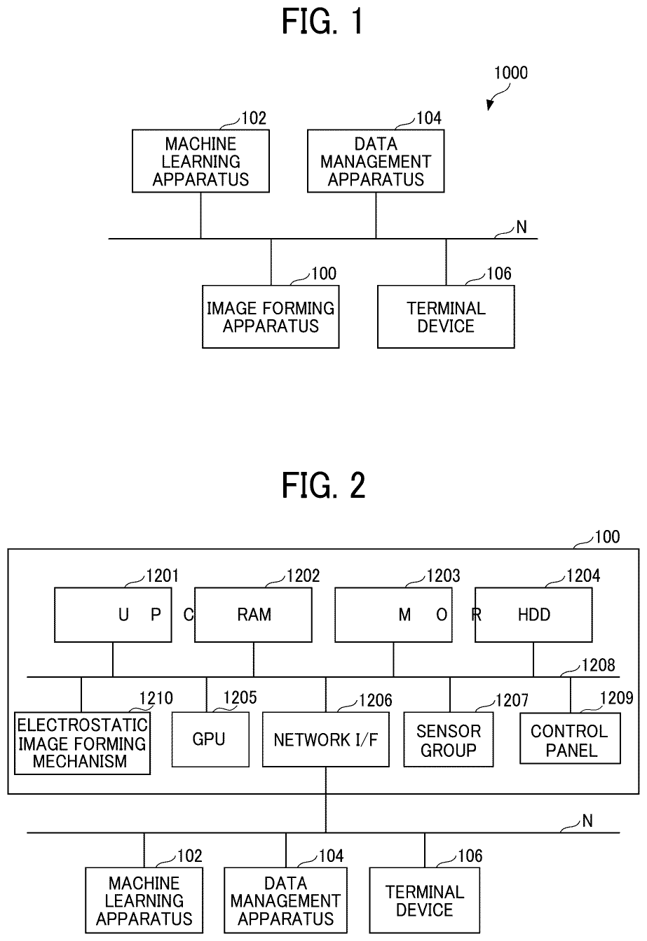

The overall configuration of an image forming system will be described with reference to FIG. 1. FIG. 1 is a schematic block diagram of an image forming system 1000.

As illustrated in FIG. 1, the image forming system 1000 includes an image forming apparatus 100, a machine learning apparatus 102, a data management apparatus 104, and a terminal device 106. The image forming apparatus 100, the machine learning apparatus 102, the data management apparatus 104, and the terminal device 106 are connected to a communication network N. The communication network N enables communication between the connected apparatuses.

The communication network N is, for example, a wired communication network, such as the Internet, a local area network (LAN), or a wide area network (WAN). The communication network N may be a wireless communication network, such as a wireless LAN, short-range wireless communication network, or mobile communication network. In the communication network N, a wired communication network and a wireless communication network may be mixed.

The image forming apparatus 100 is an example of an electronic apparatus that forms an image on an image forming medium. The image forming apparatus 100 may be another electronic apparatus, such as a printer, a copier, a multifunction peripheral, or a facsimile machine. The image forming apparatus 100 has an artificial intelligence (AI) function. The image forming apparatus 100 detects the sign of occurrence of an image defect with the AI function, using the charging current of the photoconductor as an input parameter.

The machine learning apparatus 102 is an example of an information processing apparatus that generates a machine learning model for implementing the AI function. The machine learning apparatus 102 may be, for example, a computer such as a personal computer, a workstation, or a server.

The data management apparatus 104 is an example of an information processing apparatus that manages training data used for generating a machine learning model. The data management apparatus 104 may be, for example, a computer such as a personal computer, a workstation, or a server. The data management apparatus 104 collects information to be included in the training data from an external device, such as the image forming apparatus 100, and provides the information to the machine learning apparatus 102.

The terminal device 106 is an example of an information processing apparatus operated by the user of the image forming system 1000. The terminal device 106 may be a computer, such as a personal computer, a tablet terminal, or a smartphone. The user may be, for example, a person who uses the image forming apparatus 100 or a maintenance engineer in charge of maintenance of the image forming apparatus 100. The terminal device 106 may transmit image data to the image forming apparatus 100 in response to an operation of the user. The terminal device 106 may receive a notification indicating the state of the image forming apparatus 100 from the image forming apparatus 100 and present the notification to the maintenance engineer.

The image forming apparatus 100 receives the machine learning model generated by the machine learning apparatus 102 as the occasion arises, and implements the AI function using the machine learning model. The machine learning apparatus 102 receives training data for training a machine learning model for implementing the AI function from an external device, such as the image forming apparatus 100, the data management apparatus 104, or the terminal device 106. Then, the machine learning apparatus 102 generates a machine learning model by executing a learning process using a part of or the entire training data received from the external device.

Although FIG. 1 illustrates a configuration in which the machine learning apparatus 102 or the data management apparatus 104 is outside the image forming apparatus 100, the image forming apparatus 100 may include at least one of the functions of collecting training data and the function of generating a machine learning model.

### Hardware Configuration of Image Forming System

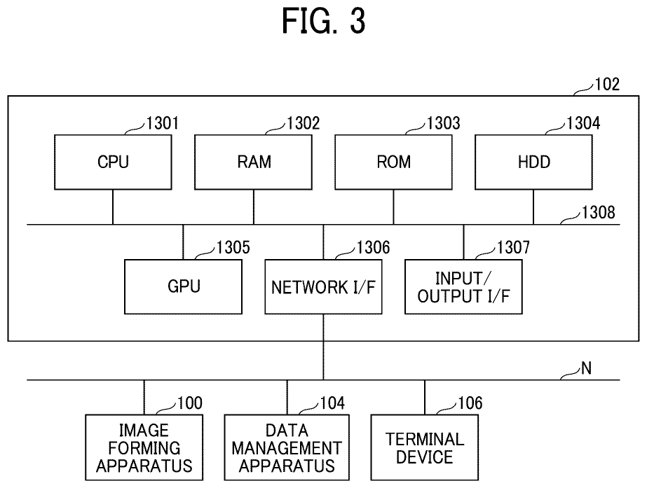

A hardware configuration of the image forming system 1000 is described below with reference to FIGS. 2 and 3. FIG. 2 is a block diagram illustrating the hardware configuration of the image forming apparatus 100. FIG. 3 is a block diagram illustrating the hardware configuration of the machine learning apparatus 102.

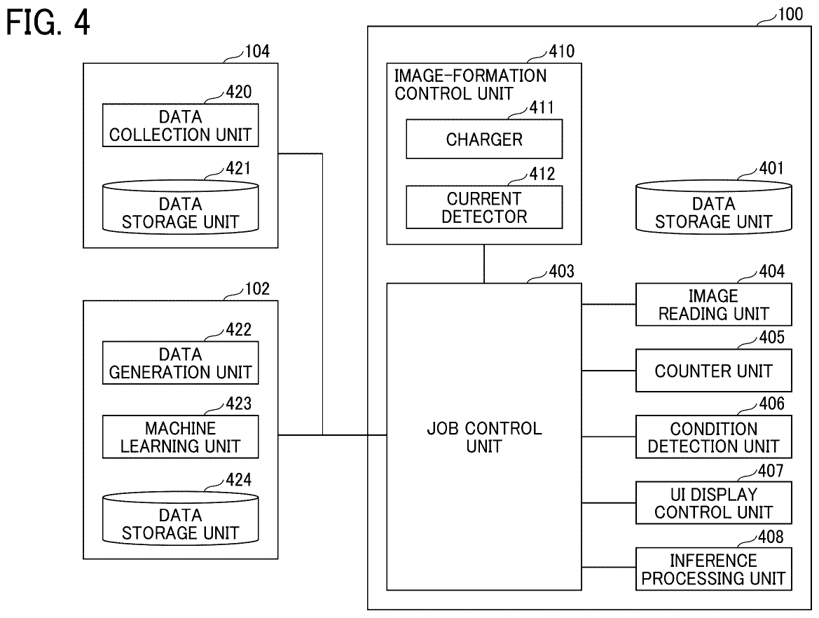

As illustrated in FIG. 2, the image forming apparatus 100 has a hardware configuration including a central processing unit (CPU) 1201, a random-access memory (RAM) 1202, a read-only memory (ROM) 1203, a hard disk drive (HDD) 1204, a graphic processing unit (GPU) 1205, a network interface (I/F) 1206, a sensor group 1207 including various sensors (e.g., a current detector 412 in FIG. 4), a control panel 1209, and an electrostatic image forming mechanism 1210. The CPU 1201, the RAM 1202, the ROM 1203, the HDD 1204, the GPU 1205, the network I/F 1206, the sensor group 1207, and the control panel 1209 are connected to each other via a system bus 1208. The control panel 1209 includes buttons and keys, such as a start button, and a display.

The CPU 1201 is a controller that controls the overall operation of the image forming apparatus 100. The RAM 1202 is a system work memory for the CPU 1201 to perform operations, and also serves as an image memory for temporarily storing data such as image data. The ROM 1203 stores data such as the programs to be executed by the CPU 1201.

The HDD 1204 stores data such as system software, image data, and software counter values. The image forming apparatus 100 may include another type of storage device, such as a solid-state drive (SSD), instead of or in addition to the HDD.

The GPU 1205 processes a large amount of data in parallel to achieve efficient computing. The GPU 1205 may implement the process executed by an inference processing unit 408 described later. Alternatively, the process executed by the inference processing unit 408 may be implemented by the computing by either the CPU 1201 or the GPU 1205.

The network I/F 1206 is connected to the communication network N and enables communication with the machine learning apparatus 102, the data management apparatus 104, the terminal device 106, or other information processing apparatuses. The network I/F 1206 may have a wireless communication function for, for example, data communication with an external facsimile machine or wireless communication with an external terminal device.

As illustrated in FIG. 3, the machine learning apparatus 102 has a hardware configuration including the CPU 1301, the RAM 1302, the ROM 1303, the HDD 1304, the GPU 1305, a network I/F 1306, and an input/output I/F 1307. The CPU 1301, the RAM 1302, the ROM 1303, the HDD 1304, the GPU 1305, the network I/F 1306, and the input/output I/F 1307 are connected to each other via a system bus 1308.

The CPU 1301 reads out programs, such as an operating system (OS) and application software, from the HDD 1304 and executes the programs to provide various functions. The RAM 1302 is the system work memory for the CPU 1301 to execute the programs. The ROM 1303 stores programs for activating, for example, a basic input/output system (BIOS) and the OS, and setting files.

The HDD 1304 stores system software and other data. The machine learning apparatus 102 may include another type of storage device, such as an SSD, instead of or in addition to the HDD.

The GPU 1305 processes a large amount of data in parallel to achieve efficient computing. When machine learning is performed multiple times using, for example, deep learning, the processing using the GPU 1305 is effective. The GPU 1305 is used in addition to the CPU 1301 to implement the processing by a machine learning unit 423 illustrated in FIG. 4, which will be described later. For example, when the machine learning apparatus 102 executes a learning program for generating a machine learning model, the CPU 1301 and the GPU 1305 perform calculation in cooperation with each other. The processing by the machine learning unit 423 may be implemented by the computing by the CPU 1301 or the GPU 1305.

The network I/F 1306 is connected to the communication network N and enables communication with the image forming apparatus 100, the data management apparatus 104, the terminal device 106, or other external information processing apparatuses.

The input/output I/F 1307 is an interface that inputs and outputs information to and from a control panel (operation device). The control panel may be, for example, a touch screen display including an input device, such as a multi-touch sensor, and an output device, such as a liquid crystal display. On the control panel, information is drawn at a predetermined resolution and in colors specified by the screen information generated by the program. For example, a graphical user interface (GUI) screen is drawn on the control panel, and various windows and data for operation are displayed on the GUI screen. The control panel may not be included in the machine learning apparatus 102 or the data management apparatus 104.

The data management apparatus 104 and the terminal device 106 can be implemented by a hardware configuration similar to that of the machine learning apparatus 102.

The overall configuration of the image forming system 1000 illustrated in FIG. 1 is an example, and various system configurations will be employed depending on applications and purposes. The machine learning apparatus 102 and the data management apparatus 104 may be implemented on the same computer. The image forming apparatus 100 may have functions similar to those of the machine learning apparatus 102 or the data management apparatus 104.

For example, each of the machine learning apparatus 102 and the data management apparatus 104 may be implemented by one computer or may be implemented by multiple computers. Alternatively, the machine learning apparatus 102 and the data management apparatus 104 may be implemented by cloud computing.

### Functional Configuration of Image Forming System

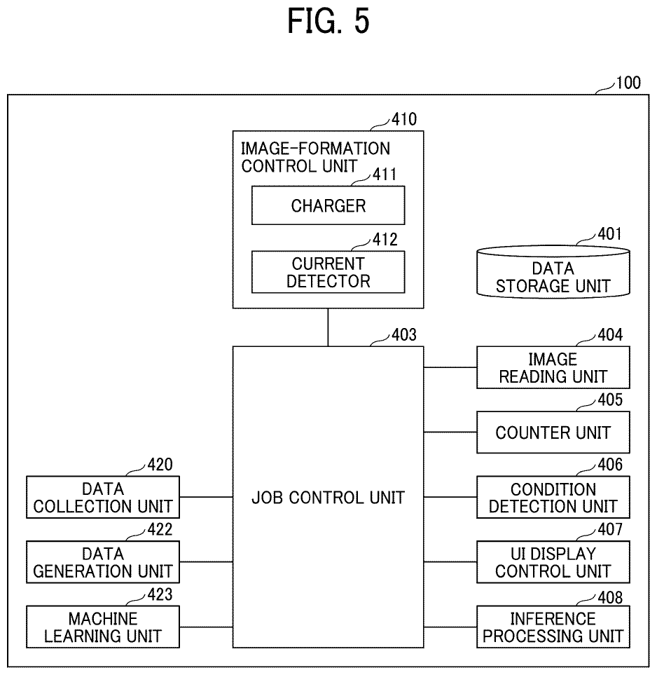

A functional configuration of the image forming system 1000 is described below with reference to FIGS. 4 and 5. FIG. 4 is a block diagram illustrating the functional configuration of the image forming system 1000.

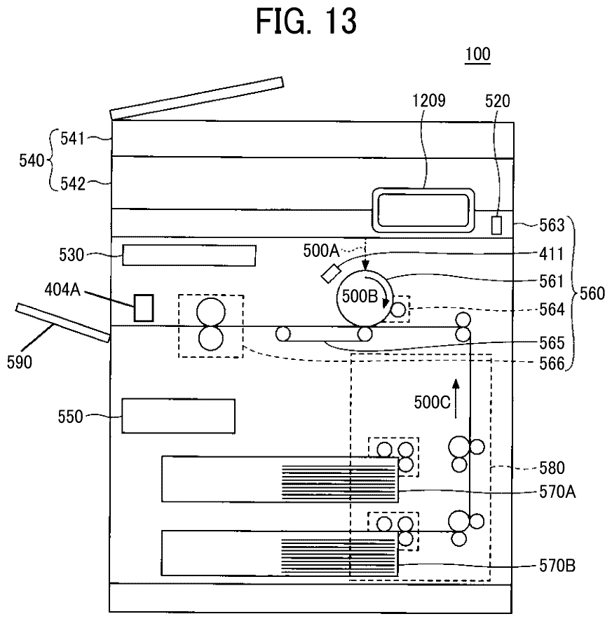

As illustrated in FIG. 4, the image forming apparatus 100 has a software configuration including a data storage unit 401, a job control unit 403, an image reading unit 404, a counter unit 405, a condition detection unit 406, a user interface (UI) display control unit 407, an inference processing unit 408, and an image-formation control unit 410. The image-formation control unit 410 controls the charger 411 and the current detector 412, which are parts of the electrostatic image forming mechanism 1210. The electrostatic image forming mechanism 1210 forms a toner image on a photoconductor 561 (see FIG. 13).

The software configuration of the image forming apparatus 100 is implemented by the hardware resources illustrated in FIG. 2 and programs. The programs to implement the functional configuration of the image forming apparatus 100 are stored in the HDD 1204 for each component, read into the RAM 1202, and implemented by the CPU 1201. Such programs may be executed by the GPU 1205 in addition to the CPU 1201.

The data storage unit 401 stores data input or output by the image forming apparatus 100 to or from the RAM 1202 or the HDD 1204. The data input and output by the image forming apparatus 100 includes image data, training data, and machine learning models.

The job control unit 403 executes basic functions of the image forming apparatus 100 according to instructions from the user. The user's instruction may be input through the control panel of the image forming apparatus 100 or received from the terminal device 106. The basic functions of the image forming apparatus 100 include printing, copying, scanning, and faxing. The job control unit 403 may transmit and receive instructions or data to and from other components in relation to the execution of the basic function.

The image reading unit 404 reads, with a scanner, an image formed on an image forming medium according to an instruction from the job control unit 403. The image reading unit 404 may perform reading of a document using the scanner when executing, for example, copying or scanning. The image reading unit 404 may perform optical reading of a recording sheet using, for example, an in-line sensor inside the image forming apparatus 100.

The image reading unit 404 may detect an image defect of an image formed on an image forming medium based on the read image. The image reading unit 404 may detect an image defect based on reference data. The reference data may include input image data and print settings (for example, various setting values such as a printing method or the number of copies). The image reading unit 404 reads an image formed on an image forming medium based on the reference data to generate read image data. The image reading unit 404 compares the input image data with the read image data to detect an image defect. The image defect may include a missing portion, a streak, a blur, and unevenness.

The counter unit 405 records various counter values in the image forming apparatus 100. The counter value may include the total number of printed sheets.

The condition detection unit 406 detects the state of the image forming apparatus 100. The condition detection unit 406 may detect the state of the image forming apparatus 100, for example, when a print job is received. Information indicating the state of the image forming apparatus 100 detected by the condition detection unit 406 may be collected by the data collection unit 420 and stored in the data storage unit 421.

The UI display control unit 407 generates screen information for displaying screens used by the user to operate the image forming apparatus 100. The UI display control unit 407 may display a notification on the state of the image forming apparatus 100.

The UI display control unit 407 may indicate the state of the image forming apparatus 100 by, for example, screen display, blinking of a light emitting diode (LED), or sound.

The inference processing unit 408 executes an inference process (determination process) to implement the AI function. The inference processing unit 408 may perform an inference process on data input and output by the image forming apparatus 100 using a machine learning model generated by the machine learning apparatus 102. For example, the inference processing unit 408 may determine the condition of the photoconductor 561 based on the charging current flowing when the photoconductor 561 is charged.

The inference processing unit 408 may input the detection result of the charging current to the machine learning model stored in the data storage unit 401, to obtain the determination result of the condition of the photoconductor 561. The inference processing unit 408 may transmit the detection result of the charging current to the machine learning apparatus 102 and receive the determination result of the condition of the photoconductor 561 from the machine learning apparatus 102.

The inference processing unit 408 may determine the condition of the photoconductor 561 according to an instruction from the job control unit 403. The inference processing unit 408 may transmit the determination result of the condition of the photoconductor 561 to the job control unit 403. The inference processing unit 408 may store the determination result of the condition of the photoconductor 561 in the data storage unit 401.

The determination result of the condition of the photoconductor 561 may include the detection result of the charging current and information indicating the state. The information indicating the condition may include a normal flag indicating a normal condition and an abnormal flag indicating an abnormal condition.

When determining that the condition of the photoconductor 561 is not abnormal (the condition of the photoconductor 561 is normal), the inference processing unit 408 sets a normal flag in the determination result. When the condition of the photoconductor 561 is determined to be abnormal, the inference processing unit 408 sets an abnormal flag in the determination result. The abnormal flag may include identification information indicating the type of abnormality. The identification information indicating the type of abnormality may be, for example, information that can specify a portion that causes the abnormality. The portion that causes the abnormality may include the photoconductor 561.

When the condition of the photoconductor 561 is determined to be abnormal, the inference processing unit 408 may display the determination result of the condition of the photoconductor 561 on a display device, such as a control panel. The determination result of the condition of the photoconductor 561 may include identification information indicating the type of abnormality. Accordingly, the image forming apparatus 100 can notify the user who uses the image forming apparatus 100 of the abnormality of the image forming apparatus 100.

When the photoconductor 561 is determined to be in an abnormal condition, the inference processing unit 408 may transmit the determination result of the condition of the photoconductor 561 to the terminal device 106. The terminal device 106 may display the determination result received from the image forming apparatus 100 on the display device. Accordingly, the image forming apparatus 100 can notify the maintenance engineer who maintains the image forming apparatus 100 of the abnormality of the image forming apparatus 100.

The image-formation control unit 410 forms an image on an image forming medium according to an instruction from the job control unit 403. The image forming medium on which an image is formed by the image-formation control unit 410 is stacked on an output tray 590 (see FIG. 13) in the image forming apparatus 100. The charger 411 generates a charging voltage to be applied to the photoconductor 561 at the time of image formation and charges the photoconductor 561 under the control of the image-formation control unit 410. The current detector 412 detects the charging current that flows when the photoconductor 561 is charged.

A reader 404A (see FIG. 13) controlled by the image reading unit 404 may be located between the photoconductor 561 and the output tray 590. This configuration allows the formation of an image on an image forming medium by the image-formation control unit 410 using the photoconductor 561 and allows the reading of the image on the image forming medium. In other words, when an image is formed on an image forming medium based on the input image data, it is not necessary to separately read the image forming medium to generate the read image data. This reduces the time and effort to detect an image defect.

As illustrated in FIG. 4, the data management apparatus 104 has a software configuration including a data collection unit 420 and a data storage unit 421.

The software configuration of the data management apparatus 104 is implemented by the hardware resources illustrated in FIG. 3 and programs. The programs to implement the functional configuration of the data management apparatus 104 are stored in the HDD 1304 for each component, read into the RAM 1302, and implemented by the CPU 1301.

The data collection unit 420 collects history data. The history data is the source of the training data, and includes information unique to the user environment related to the image forming apparatus 100. For example, the history data may include information indicating the detection results of the charging current and the condition of the photoconductor 561. The information indicating the condition of the photoconductor 561 may be the determination result of the condition of the photoconductor 561.

The data collection unit 420 may collect history data from the image forming apparatus 100. The data collection unit 420 may store the history data collected from the image forming apparatus 100 in the data storage unit 421.

The data collection unit 420 may provide the history data to the machine learning apparatus 102. The data collection unit 420 may read the history data from the data storage unit 421 and transmit the history data to the machine learning apparatus 102.

The data storage unit 421 stores the history data. The data storage unit 421 may store the history data collected by the data collection unit 420 in the storage device such as the RAM 1302 or the HDD 1304. The data storage unit 421 may read the history data from the storage device such as the RAM 1302 or the HDD 1304 according to an instruction from the data collection unit 420.

As illustrated in FIG. 4, the machine learning apparatus 102 has a software configuration including a data generation unit 422, a machine learning unit 423, and a data storage unit 424.

The software configuration of the machine learning apparatus 102 is implemented by the hardware resources illustrated in FIG. 3 and programs. The programs to implement the functional configuration of the machine learning apparatus 102 are stored in the HDD 1304 for each component, read into the RAM 1302, and implemented by the CPU 1301. Such programs may be executed by the GPU 1305 in addition to the CPU 1301.

The data generation unit 422 generates training data. The data generation unit 422 may generate the training data based on the history data from the data management apparatus 104. For example, the data generation unit 422 may remove unnecessary data that becomes noise from the history data to obtain desired learning effects. The data generation unit 422 may, for example, adjust the format of the history data input to the machine learning model, thereby generating the training data.

The machine learning unit 423 generates a machine learning model. The machine learning unit 423 may generate a machine learning model based on the training data generated by the data generation unit 422. The machine learning unit 423 may input the training data to the machine learning model and update the parameters of the machine learning model so as to minimize the loss calculated based on the output of the machine learning model.

The machine learning unit 423 may retrain the machine learning model. The machine learning unit 423 may retrain the learned machine learning model based on the training data generated by the data generation unit 422. The training data for retraining may be generated based on the history data collected after training or retraining the machine learning model.

The data storage unit 424 stores the history data, the training data, and the machine learning model. The data storage unit 424 may store the history data received from the data management apparatus 104. The data storage unit 424 may store the training data generated by the data generation unit 422. The data storage unit 424 may store the machine learning model generated by the machine learning unit 423.

FIG. 5 is a block diagram illustrating another functional configuration of the image forming system 1000. As illustrated in FIG. 5, the image forming apparatus 100 may have a software configuration including a data storage unit 401, a job control unit 403, an image reading unit 404, a counter unit 405, a condition detection unit 406, an UI display control unit 407, an inference processing unit 408, an image-formation control unit 410, a data collection unit 420, a data generation unit 422, and a machine learning unit 423.

In other words, the image forming apparatus 100 may further have the software configurations of the machine learning apparatus 102 and the data management apparatus 104. In this case, the image forming system 1000 may not include the machine learning apparatus 102 and the data management apparatus 104. In this case, the pieces of data stored in the data storage units 401, 421, and 424 illustrated in FIG. 4 are consolidated and stored in the data storage unit 401.

### Machine Learning Model

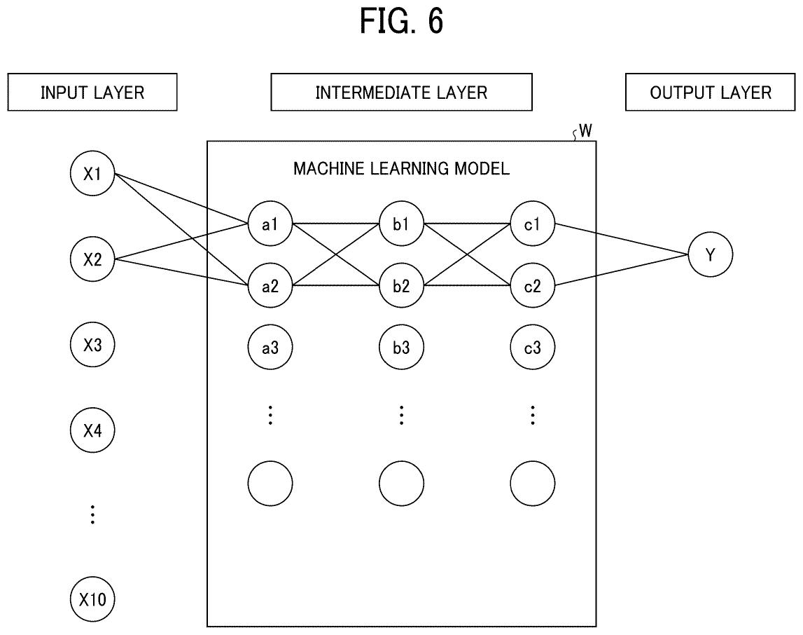

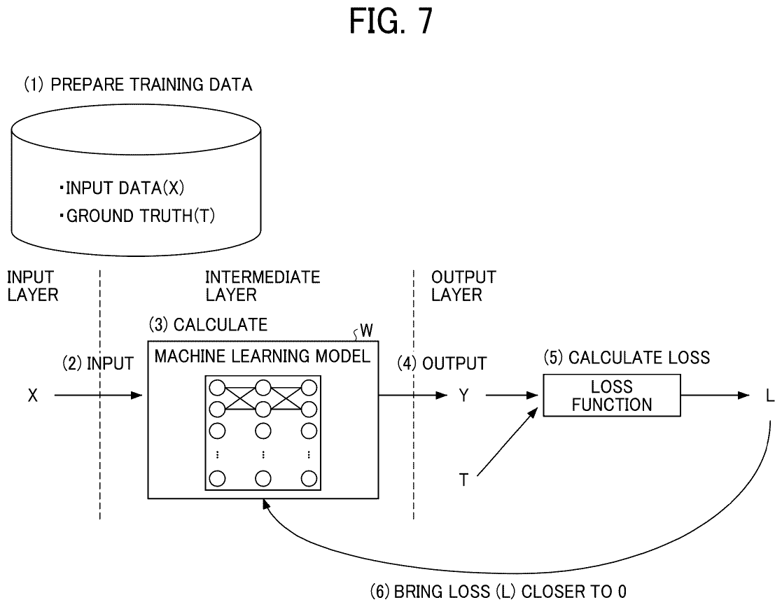

The machine learning model is described below with reference to FIGS. 6 and 7. FIG. 6 is a diagram illustrating a machine learning model. FIG. 7 is a diagram illustrating a learning process.

Examples of algorithms of machine learning include neural networks, nearest neighbors, naive Bayes, decision trees, and support vector machines. Another example is deep learning, which uses neural networks to generate feature values and connection weights for learning. Any available algorithm can be selected from the above-mentioned algorithms. FIGS. 6 and 7 illustrate the structure of a neural network, which is an example of a machine learning model, and a learning process.

As illustrated in FIG. 6, a machine learning model W has an input layer, one or more intermediate layers, and an output layer. The input layer receives pieces of input data X (X1 to X10). The intermediate layer has connection weights a (a1, a2, . . . ), b (b1, b2, . . . ), and c (c1, c2, . . . ), specific to each layer. The output layer outputs output data Y. The input data X1 to X10 may include, for example, the environmental information of the image forming apparatus 100, the charging current values detected by the current detector 412, the type of toner, and the information on the photoconductor at the shipment. The output data Y may include the determination result of the condition of the photoconductor.

The input data X1 to X10 may include any information related to factors concerning the determination of the condition of the photoconductor and the detection of signs of image defects. For example, the input data X1 through X10 may include other data, such as data available from the sensor 1207 installed in the image forming apparatus 100. Needless to say, the elements of the input data X are not limited to the above-mentioned elements.

As indicated in (1) in FIG. 7, the training data includes a large number of data sets each including input data X and a ground truth T. The input data X is input data for which the ground truth T is known. (2) The machine learning unit 423 inputs the input data X into the input layer of the machine learning model W. (3) The machine learning model W performs calculations using the connection weights a, b, and c on the input data X. (4) The machine learning model W outputs the output data Y from the output layer. (5) The machine learning unit 423 calculates a loss L that indicates the error between the output data Y and the training data T based on the loss function using the output data Y and the ground truth T.

(6) The machine learning unit 423 updates the parameters of the machine learning model W to minimize the loss L (to bring the loss L close to 0). The parameters of the machine learning model W may include the connection weights a, b, and c between the nodes of the neural network. The machine learning unit 423 may update parameters such as the connection weights between the nodes of the neural network using, for example, error backpropagation. Error backpropagation is a method of adjusting parameters such as the connection weights between the nodes of the neural network to reduce the error between the output of the neural network and the ground truth.

For example, the training data is generated as follows. The ground truth T is information that indicates whether an image formed using multiple photoconductors includes an image defect. The properties, such as film thickness or surface condition, of the photoconductors used in generating training data are measured in advance. The input data X includes the information indicating the situation of the image forming apparatus and charging current value at the time of formation of images to obtain the ground truth T. The situation of the image forming apparatus may include temperature, humidity, the information on the toner used, and data obtained in the pre-shipment inspection of the photoconductor.

In the training data, the input data T may include the charging current value and the image data obtained by reading the formed image. This allows the machine learning unit 423 to input the charging current value and the image data to the machine learning model W and cause the machine learning model W to learn image defects that occur when the photoconductor is in an abnormal condition. This enables the machine learning unit 423 to perform learning for determining whether the photoconductor relates to the image defect caused by changes in the charging current value.

The machine learning unit 423 may retrain the machine learning model as follows. For example, when the photoconductor 561 is determined to be in an abnormal condition, the user evaluates the determination result and inputs the result of evaluation to the image forming apparatus 100. The result of evaluation may be input to, for example, a screen displayed on a control panel of the image forming apparatus 100. The screen may be configured to receive evaluation values, such as “satisfied (image defect has occurred)” or “unsatisfied (image defect has not occurred).” The user checks the image formed on the image forming medium, and inputs “satisfied” when the user finds an image defect, and inputs “unsatisfied” when the user finds no image defect. Alternatively, the user may take out the photoconductor 561 from the image forming apparatus 100, and input “satisfied (the condition of the photoconductor 561 is abnormal)” when the abnormal condition of the photoconductor 561 is found, and input “unsatisfied (the condition of the photoconductor 561 is normal)” when no abnormal condition is found. The abnormal condition of the photoconductor 561 may include a scratch or a waviness on the surface of the photoconductor 561, and substances adhering to the surface of the photoconductor 561.

The image forming apparatus 100 transmits the evaluation result input by the user to the machine learning apparatus 102.

The machine learning apparatus 102 uses the determination result to which “satisfied” is input as the ground truth T of new training data. The machine learning apparatus 102 may use the determination result to which “unsatisfied” is input as the ground truth T of new training data. When a certain amount of new training data is accumulated, the machine learning apparatus 102 retrains the machine learning model based on the accumulated new training data. Accordingly, the machine learning model can reflect the information unique to the user or the image forming apparatus in the subsequent detection of signs of the occurrence of image defects. For example, since the user inputs the evaluation value according to the user's preference, the machine learning model can detect the signs of the occurrence of image defects according to the user's preference.

### Abnormality Detection Process

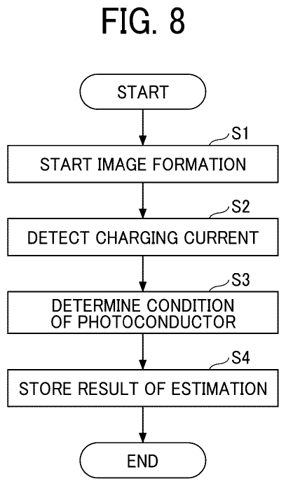

An abnormality detection process executed by the image forming system 1000 will be described with reference to FIG. 8. FIG. 8 is a flowchart of the abnormality detection process.

In step S1, the job control unit 403 of the image forming apparatus 100 instructs the image-formation control unit 410 to form an image according to the instruction of the user. The image-formation control unit 410 starts image formation in response to an instruction from the job control unit 403. Specifically, the image-formation control unit 410 controls the charger 411 to charge the photoconductor 561. The charger 411 applies a charging voltage to the photoconductor 561 under the control of the image-formation control unit 410. As a result, the photoconductor 561 is charged.

In step S2, the image-formation control unit 410 of the image forming apparatus 100 controls the current detector 412 to detect the charging current. The current detector 412 detects the charging current that flows when the photoconductor 561 is charged. The current detector 412 transmits the detection result of the charging current to the inference processing unit 408.

In step S3, the inference processing unit 408 of the image forming apparatus 100 receives the detection result of the charging current from the current detector 412. The inference processing unit 408 determines the condition of the photoconductor 561 based on the learned machine learning model.

For example, the inference processing unit 408 may input the detection result of the charging current to the machine learning model stored in the data storage unit 401. The machine learning model determines the condition of the photoconductor 561 based on the detection result of the input charging current and outputs the determination result. The inference processing unit 408 obtains the determination result output from the machine learning model.

For example, the inference processing unit 408 may transmit the detection result of the charging current to the machine learning apparatus 102. The machine learning unit 423 of the machine learning apparatus 102 may input the detection result of the charging current received from the image forming apparatus 100 into the machine learning model stored in the data storage unit 424. The machine learning model determines the condition of the photoconductor 561 based on the detection result of the input charging current and outputs the determination result. The machine learning unit 423 obtains the determination result output from the machine learning model and transmits the result to the image forming apparatus 100. The inference processing unit 408 of the image forming apparatus 100 receives the determination result from the machine learning apparatus 102.

In step S4, the inference processing unit 408 of the image forming apparatus 100 determines whether the photoconductor 561 is in an abnormal condition based on the determination result of the condition of the photoconductor 561. The inference processing unit 408 stores the determination result with the abnormal flag in the data storage unit 401 when the photoconductor 561 is in an abnormal condition. By contrast, the inference processing unit 408 stores the determination result with the normal flag in the data storage unit 401 when the photoconductor 561 is not in an abnormal condition (is in the normal condition).

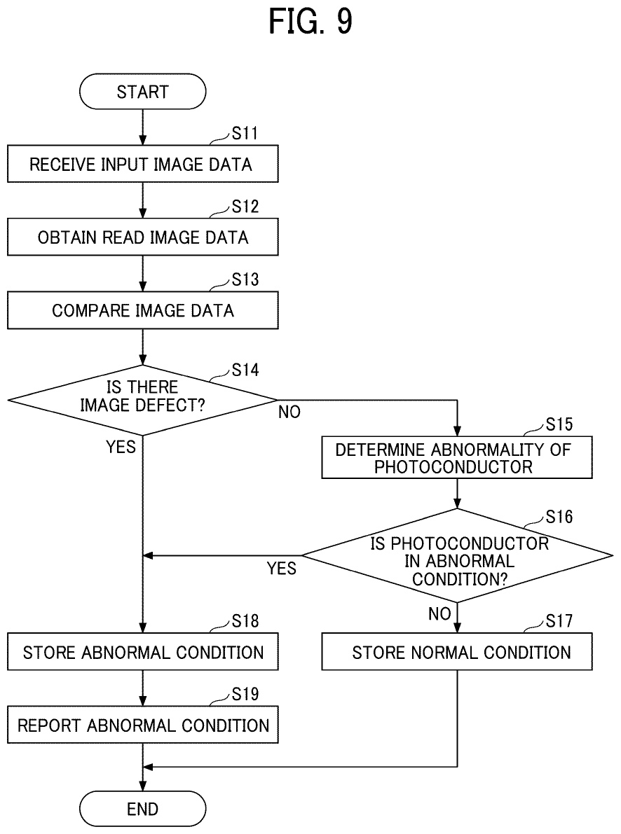

FIG. 9 is a flowchart of another abnormality detection process. In the abnormality detection process illustrated in FIG. 9, the detection of image defects is combined with the determination of the condition of the photoconductor 561.

In step S11, the job control unit 403 of the image forming apparatus 100 receives reference data from the terminal device 106. The job control unit 403 instructs the image-formation control unit 410 to perform image formation using the input image data included in the reference data.

The image-formation control unit 410 starts image formation in response to an instruction from the job control unit 403.

At this time, the charger 411 applies a charging voltage to the photoconductor 561 under the control of the image-formation control unit 410. The current detector 412 detects the charging current that flows when the photoconductor 561 is charged. The current detector 412 stores the detection result of the charging current in the data storage unit 401.

The image-formation control unit 410 forms an image based on the input image data on the image forming medium using the charged photoconductor 561. The image forming medium on which an image is formed by the image-formation control unit 410 is stacked in the output tray 590 of the image forming apparatus 100.

In step S12, the image reading unit 404 of the image forming apparatus 100 reads the image formed on the image forming medium. The image reading unit 404 may read the image before the image formed on the recording medium is stacked on the output tray 590. The image reading unit 404 generates read image data that represents the read image.

In step S13, the image reading unit 404 of the image forming apparatus 100 compares the input image data with the read image data. The image reading unit 404 detects an image defect based on the comparison result of the input image data and the read image data.

In step S14, the image reading unit 404 of the image forming apparatus 100 determines whether an image defect has been detected. When an image defect is detected (YES), the image reading unit 404 proceeds to step S18. By contrast, when no image defect is detected (NO), the image reading unit 404 proceeds to step S15.

In step S15, the inference processing unit 408 of the image forming apparatus 100 retrieves the detection result of the charging current from the data storage unit 401. The inference processing unit 408 determines the condition of the photoconductor 561 based on the learned machine learning model. The inference processing unit 408 may input the detection result of the charging current to the machine learning model to obtain the determination result of the condition of the photoconductor 561. The inference processing unit 408 may transmit the detection result of the charging current to the machine learning apparatus 102 and receive the determination result of the condition of the photoconductor 561 from the machine learning apparatus 102.

In step S16, the inference processing unit 408 of the image forming apparatus 100 determines whether the condition of the photoconductor 561 has been determined to be abnormal. When the condition of the photoconductor 561 is determined to be abnormal (YES), the inference processing unit 408 proceeds to step S18. When the condition of the photoconductor 561 is not determined to be abnormal (NO), the inference processing unit 408 proceeds to step S17.

In step S17, the inference processing unit 408 of the image forming apparatus 100 stores the determination result of the condition of the photoconductor 561 in the data storage unit 401. The inference processing unit 408 sets a normal flag on the determination result stored in the data storage unit 401.

In step S18, the inference processing unit 408 of the image forming apparatus 100 stores the determination result of the condition of the photoconductor 561 in the data storage unit 401. The inference processing unit 408 sets an abnormal flag on the determination result stored in the data storage unit 401. The abnormal flag set by the inference processing unit 408 may include identification information indicating the type of abnormality.

In step S19, the inference processing unit 408 of the image forming apparatus 100 reports the condition of the photoconductor 561. For example, the inference processing unit 408 may display the determination result of the condition of the photoconductor 561 on a display device, such as a control panel. Alternatively, the inference processing unit 408 may transmit the determination result of the condition of the photoconductor 561 to the terminal device 106. The terminal device 106 may display the determination result of the condition of the photoconductor 561 on the display device.

### Relationship Between Photoconductor Condition and Changes in Charging Current

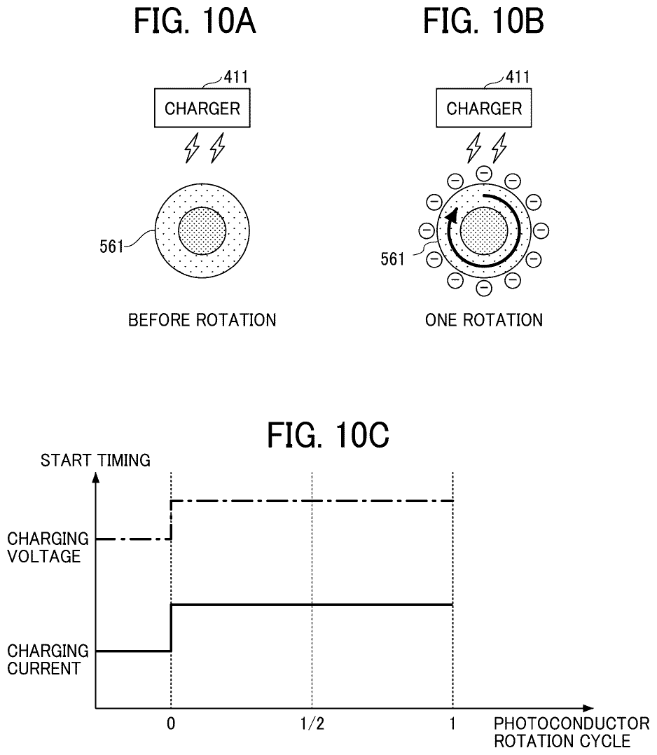

The relationship between the condition of the photoconductor and the changes in the charging current will be described in further detail below with reference to FIGS. 10A to 12C.

FIGS. 10A to 10C are diagrams illustrating the charging current detected in normal operation. FIGS. 10A and 10B each illustrate a photoconductor 561 in a normal condition with no abnormalities observed. When the charger 411 applies the charging voltage to the photoconductor 561, a charging current I, corresponding to the applied voltage indicated in Expression 1, flows from the photoconductor to a charger.

$$\begin{matrix}[ Expression 1 ] & \\ I = \frac{dq}{dt} = C \frac{dv}{dt} = ε \frac{S}{d} \frac{dv}{dt} & ( 1 )\end{matrix}$$

where t represents time, q represents the charge accumulated in the photoconductor, v represents the applied voltage, C represents the electrostatic capacity of the photoconductor, F represents the dielectric constant of the surface layer of the photoconductor, S represents the surface area of the photoconductor contributing to the charging, and d represents the thickness of the surface layer of the photoconductor.

In the charging, the photoconductor 561 is rotated while being applied with the voltage from the charger 411 so that the entire photoconductor 561 is charged. When the application of voltage to the photoconductor 561 is started from a non-charged state, current flows for the duration of the full rotation of the photoconductor 561. From the second rotation, the charged portion of the photoconductor 561 comes to the position of the charger 411, so no current flows. As illustrated in FIG. 10C, when the dielectric film on the surface of the photoconductor 561 has no abnormalities, a periodic change does not arise in the current flowing in charging.

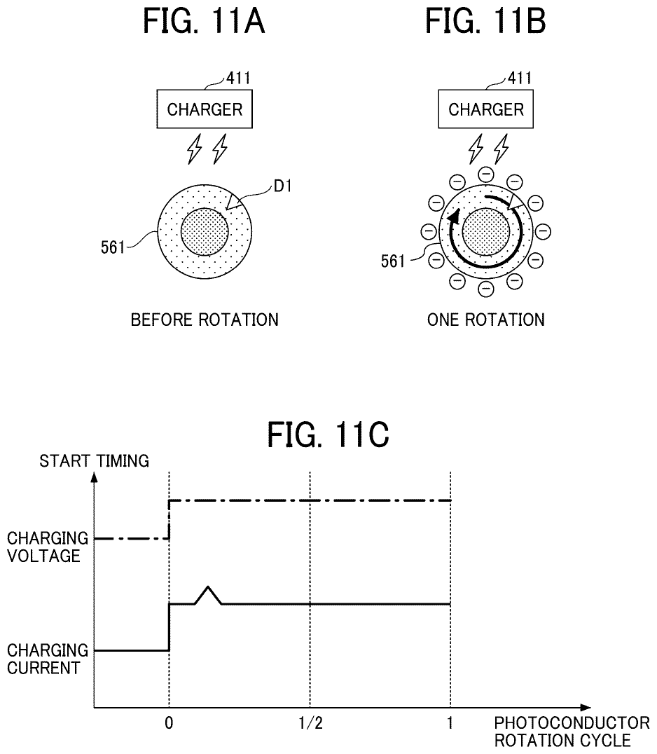

FIGS. 11A to 11C are diagrams illustrating the charging current detected when the photoconductor surface has a flaw. In FIGS. 11A and 111B, the photoconductor 561 has a flaw D1 on its surface. When the surface of photoconductor 561 has the flaw D1, the dielectric film becomes locally thinner. As a result, as illustrated in FIG. 11C, when the flaw D1 comes to the position of the charger 411, the charging current locally increases.

When the flaw D1 is a minor flaw, the flaw D1 will not affect the formed image and cause image defects. By contrast, even if the flaw D1 is a minor flaw, the flow D1 may, over time, cause filming—a deposition of an impurity layer—on the photoconductor, resulting in image defects or charging failure due to reduced chargeability. Accordingly, the determination of a minor flaw on the photoconductor that does not cause image defects leads to the detection of the signs of the occurrence of image defects.

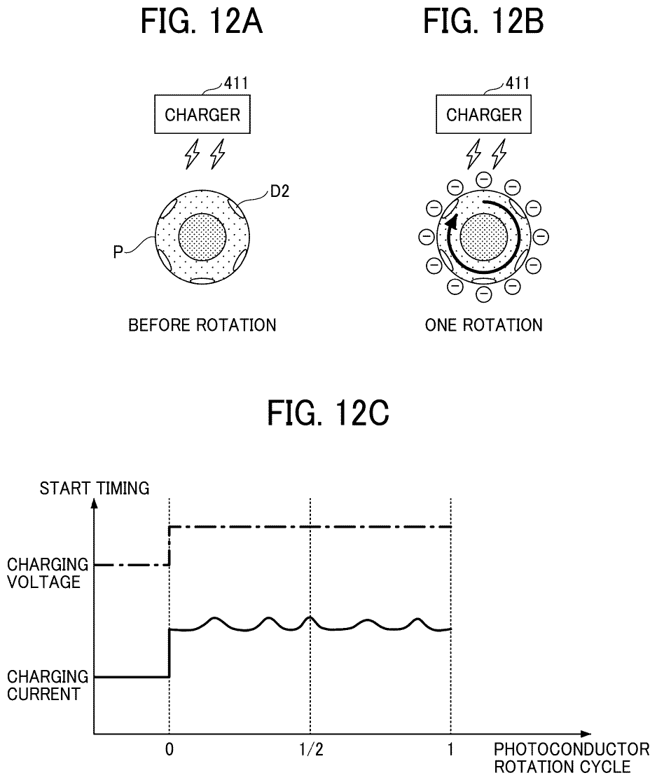

FIGS. 12A to 12C are diagrams illustrating the charging current detected when the photoconductor surface has a ripple. In FIGS. 12A and 12B, the surface of the photoconductor 561 has a ripple D2 of thickness. As illustrated in FIG. 12C, when the thickness of the dielectric film on the surface of the photoconductor 561 is uneven, the charging current changes periodically. In this case, when the ripple is slight, the photoconductor 561 is properly charged, and image defects do not arise. In the portion where the current is locally excessive, however, the photoconductor 561 is affected, and filming occurs over time, leading to image defects.

It is conceivable to establish a threshold against the charging current value to project the condition of the photoconductor as illustrated in FIGS. 10A to 12C. However, it is challenging to recognize local or periodic changes in the charging current as abnormalities. Additionally, it is also challenging to identify the potential factors leading to the occurrence of image defects from the results obtained.

When the charging current values detected on multiple photoconductors that tend to induce image defects are used as the training data for machine learning, conditions that may affect the images formed on the photoconductors can be determined from the charging current values in various conditions. When information such as ambient temperature and information obtained from the pre-shipment inspection of photoconductors is added to the training data, the condition can be determined with higher accuracy.

For example, when a potential abnormal condition that may cause image defects in the future is reported to the user of the image forming apparatus 100, parts can be replaced at a stage where there is no practical impact on use. Then, the occurrence of image defects is prevented. Additionally, by notifying the maintenance engineer of potential abnormal conditions, focused inspections are encouraged in regular maintenance, and the replacement of parts before the occurrence of image defects is encouraged.

FIG. 13 is a diagram illustrating a configuration of the image forming apparatus 100.

The image forming apparatus 100 is a multifunction peripheral (MFP) also referred to as a multifunction printer. The image forming apparatus 100 has copying, facsimile transmission and reception, printing, scanning, data storing, and data distributing functions. Examples of the data stored or distributed include images obtained by scanning a document, an image obtained by the printing function, and an image received by the facsimile function.

The image forming apparatus 100 communicates with an external device, such as a personal computer (PC), and operates in response to instructions received from the external device. The “image” processed by the image forming apparatus 100 includes, in addition to image data, data without image data, that is, text data.

The image forming apparatus 100 is an electrophotographic image forming apparatus that selectively exposes the charged surface of the photoconductor 561 to write an electrostatic latent image thereon, supply toner to the electrostatic latent image, and transfers the toner image onto a recording medium, such as a sheet of paper.

The image forming apparatus 100 includes the control panel 1209, a power switch 520, a controller 530, a scanner unit 540, an engine control unit 550, a printer unit 560, sheet feeding trays 570A and 570B, a conveyor unit 580, the reader 404A, and the output tray 590.

The control panel 1209 receives various types of input according to the user's operation and displays various types of information (for example, information indicating the received operation, information indicating the operating state of the image forming apparatus 100, and information indicating the settings of the image forming apparatus 100). The control panel 1209 is a liquid crystal display (LCD) having a touch screen function but is not limited an LCD. Alternatively, for example, an organic electroluminescence (EL) display having a touch-screen function may be used. In alternative to or in addition to the LCD or the EL display, an operation device such as hardware keys and/or an indicator such as a lamp may be used.

When the user presses the power switch 520 while the image forming apparatus 100 is off, the image forming apparatus 100 is turned on. Further, the image forming apparatus is turned off when the power switch 520 is pressed while the image forming apparatus 100 is activated, that is, the power is on. As described above, the power switch 520 may turn the image forming apparatus 100 on/off by being pressed by the user. In alternative to or in addition to this, the image forming apparatus 100 may be turned on/off according to an instruction received from an external device.

The controller 530 comprehensively controls the image forming apparatus 100 based on the operations input from the control panel 1209. For example, the controller 530 controls the image forming apparatus 100 to execute an operation corresponding to the operation or information received via the control panel 1209. As another example, the controller 530 controls the image forming apparatus 100 to execute an instruction received from an external device, such as a PC. As another example, the controller 530 controls the image forming apparatus 100 to execute a predetermined operation when a specific condition is detected, such as detecting the press of the power switch 520, or an abnormality occurring in the image forming apparatus 100 is detected.

The controller 530 is, for example, a controller board on which a circuit for controlling the image forming apparatus 100 is mounted. The circuit that comprehensively controls the image forming apparatus 100 includes the CPU 1201, the RAM 1202, and the ROM 1203. In the controller 530, the CPU 1201 executes programs stored in the ROM 1203 or the HDD 1204 using the RAM 1202 as a work area, to control the image forming apparatus 100.

The scanner unit 540 reads the document. The scanner unit 540 includes an automatic document feeder (ADF) 541 and a scanner 542. The ADF 541 sequentially conveys the document placed on the ADF 541 and generates image data by optical reading. The scanner 542 optically reads the document placed on a transparent document table to generate image data.

The engine control unit 550 generates a control signal for controlling the printer unit 560 and the conveyor unit 580 based on the image data generated by the scanner unit 540. The engine control unit 550 is, for example, a circuit board for generating a control signal based on image data.

The printer unit 560 is an image forming device that forms images on recording media such as paper sheets. The printer unit 560 forms a toner image on the recording medium. The printer unit 560 includes the photoconductor 561 (e.g., a photoconductor drum), the charger 411, a writing unit 563, a developing device 564, a conveyor belt 565, and a fixing unit 566. The charger 562 charges the surface of the photoconductor 561. The writing unit 563 exposes the charged photoconductor 561 based on the image data read by the scanner unit 540 to write an electrostatic latent image on the photoconductor 561. The developing device 564 develops the latent image with toner. The conveyor belt 565 conveys a recording medium on which a toner image is to be formed. The fixing unit 566 fixes the toner image on the recording medium.

The sheet feeding trays 570A and 570B contain recording media before image formation. In FIG. 13, two sheet feeding trays, storing recording media of different sizes, are used. Alternatively, one or three or more sheet feeding trays may be used.

The conveyor unit 580 conveys the recording medium. The conveyor unit 580 includes various rollers. The conveyor unit 580 conveys the recording media contained in the sheet feeding trays 570A and 570B to the printer unit 560 in the direction indicated by arrow 500C.

A sequence of copying operations as image formation in the image forming apparatus 100 will be described below. In response to the user's operation on, for example, a function switching key in the control panel 1209, the image forming apparatus 100 sequentially switches functions, such as the copy function, the print function, and the facsimile function, and executes the selected function. The user selects the copy function to set the image forming apparatus in the copy mode, selects the printer function to set the image forming apparatus in the printer mode, and selects the facsimile function to set the image forming apparatus in the facsimile mode.

In the copy mode, the scanner unit 540 reads the image information of each document to be copied and generates image data.

The surface of the photoconductor 561 is uniformly charged by the charger 411 in the dark and exposed to the irradiation light from the writing unit 563 (as indicated by dotted arrow 500A). Thus, an electrostatic latent image is formed on the surface of the photoconductor 561. The developing device 564 develops (visualizes) the electrostatic latent image with toner. As a result, a toner image is formed on the photoconductor 561. The photoconductor 561 rotates in the direction of arrow 500B. The toner image formed on the photoconductor 561 is transferred onto the recording medium on the conveyor belt 565. Then, the fixing unit 566 fuses the toner image on the recording medium with heat and fixes the toner image thereon. Then, the recording medium is ejected from the image forming apparatus 100.

Although the printer unit 560 forms images by a monochrome electronic photographic method in the description above, but the method is not limited thereto. A multicolor electronic photographic method or an inkjet method may be used.

The control panel 1209 described above may be controlled by the controller 530, or a control circuit other than the controller 530 for controlling the control panel 1209 may be used. In this case, the control circuit of the controller 530 and the control circuit of the control panel 1209 are connected to communicate with each other, and the controller 530 controls the entire image forming apparatus 100 including the control panel 1209.

The above-described image forming apparatus 100 includes the photoconductor, the charger that charges the photoconductor, the current detector that detects the charging current flowing when the photoconductor is charged, and the inference processing unit that determines the condition of the photoconductor based on a machine learning model that has learned the relationship between the charging current and the condition of the photoconductor.

In one aspect, the condition of the photoconductor is determined based on the charging current flowing when the photoconductor is charged, and thus the accuracy of abnormality detection can increase. Accordingly, since a minor abnormality that does not cause detectable image defects is determined, the signs of the occurrence of image defects are detectable.

Each of the functions of the above-described embodiments may be implemented by one or more pieces of processing circuitry. The “processing circuit or circuitry” in the present disclosure includes a programmed processor to execute each function by software, such as a processor implemented by an electronic circuit; and devices, such as an application-specific integrated circuit (ASIC), a digital signal processor (DSP), a field-programmable gate array (FPGA), and conventional circuit modules arranged to perform the recited functions.

The group of apparatuses or devices described above is one example of plural computing environments that implement the above-described embodiments. The machine learning apparatus 102 or the data management apparatus 104 may include multiple computing devices, such as a server cluster. The multiple computing devices communicate with one another through any type of communication link including, for example, a network and a shared memory, and perform the processes disclosed in the present disclosure.

Aspects of the present disclosure are, for example, as follows.

### Aspect 1

An image forming apparatus includes a photoconductor, a charger to charge a surface of the photoconductor, a current detector to detect a charging current that flows when the photoconductor is charged, and circuitry. The circuitry estimates a condition of the photoconductor using a machine learning model having learned a relationship between a charging current and the condition of the photoconductor.

### Aspect 2

In the image forming apparatus according to Aspect 1, the machine learning model is stored in an information processing apparatus with which the image forming apparatus communicates via a network, and the circuitry transmits a detection result of the charging current to the information processing apparatus and receives a determination result of the condition from the information processing apparatus.

### Aspect 3

In the image forming apparatus according to Aspect 1, the circuitry generates the machine learning model based on training data including detection results of the charging current and information indicating the condition, inputs a detection result of the charging current to the machine learning model, and obtains the determination result of the condition from the machine learning model.

### Aspect 4

In the image forming apparatus according to Aspect 3, the circuitry retrains the machine learning model based on training data including the determination result of the condition as the information indicating the condition.

### Aspect 5

In the image forming apparatus according to any one of Aspects 1 to 4, when the photoconductor is determined to be in an abnormal condition, the circuitry stores, in a memory, the determination result of the condition, and the determination result includes identification information indicating the type of abnormality.

### Aspect 6

In the image forming apparatus according to any one of Aspects 1 to 5, when the photoconductor is determined to be in an abnormal condition, the circuitry displays a notification related to the condition on a display.

### Aspect 7

In the image forming apparatus according to any one of Aspects 1 to 6, when the photoconductor is determined to be in an abnormal condition, the circuitry transmits a notification related to the condition to a terminal device via a network.

### Aspect 8

The image forming apparatus according to any one of Aspects 1 to 7 further includes an image forming device to form an image on an image forming medium using the photoconductor; and a scanner to detect an image defect in an image formed on the image forming medium. The circuitry determines the condition of the photoconductor when no image defect is detected by the scanner.

### Aspect 9

The image forming apparatus according to Aspect 8 further includes an output tray on which image forming media after image formation are stacked, and the scanner is disposed between the photoconductor and the output tray.

### Aspect 10

In an image forming system in which an image forming apparatus communicates via a network with an information processing apparatus, the image forming apparatus includes a photoconductor, a charger to charge a surface of the photoconductor, a current detector to detect a charging current that flows when the photoconductor is charged, and circuitry.

The circuitry transmits a detection result of the charging current to the information processing apparatus and receives a determination result of the condition of the photoconductor from the information processing apparatus.

The information processing apparatus includes processing circuitry that inputs the detection result of the charging current to a machine learning model having learned a relationship between a charging current and the condition of the photoconductor, to determine the condition of the photoconductor.

### Aspect 11

An abnormality detection method for a computer includes detecting a charging current that flows when a photoconductor is charged; and determining a condition of the photoconductor using a machine learning model having learned a relationship between the charging current and the condition of the photoconductor.

### Aspect 12

A program for causing a computer to execute a method including detecting a charging current that flows when a photoconductor is charged, and determining a condition of the photoconductor using a machine learning model having learned a relationship between the charging current and the condition of the photoconductor.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image forming apparatus comprising:
a photoconductor;
a charger to charge a surface of the photoconductor;
a current detector to detect a charging current that flows when the photoconductor is charged; and
circuitry configured to output a determination result of a condition of the photoconductor obtained using a machine learning model, the machine learning model having learned a relationship between the charging current and the condition of the photoconductor.

2. The image forming apparatus according to claim 1, wherein
the machine learning model is stored in an information processing apparatus with which the image forming apparatus communicates via a network, and
the circuitry is configured to transmit a detection result of the charging current to the information processing apparatus, and receive the determination result of the condition from the information processing apparatus.

3. The image forming apparatus according to claim 1,
wherein the circuitry is configured to:
generate the machine learning model based on training data including detection results of the charging current and information indicating the condition; and
input a detection result of the charging current to the machine learning model, to obtain the determination result of the condition.

4. The image forming apparatus according to claim 3,
wherein the circuitry is configured to retrain the machine learning model based on training data including the determination result of the condition as the information indicating the condition.

5. The image forming apparatus according to claim 1,
wherein, when the condition of the photoconductor is determined to be abnormal, the circuitry is configured to store, in a memory, the determination result of the condition, the determination result including identification information indicating a type of abnormality.

6. The image forming apparatus according to claim 1,
wherein, when the condition of the photoconductor is determined to be abnormal, the circuitry is configured to display a notification related to the condition on a display.

7. The image forming apparatus according to claim 1,
wherein, when the condition of the photoconductor is determined to be abnormal, the circuitry is configured to transmit a notification related to the condition to a terminal device via a network.

8. The image forming apparatus according to claim 1, wherein the circuitry is configured to:
form an image on an image forming medium using the photoconductor,
detect, with a reader, an image defect in an image formed on the image forming medium; and
determine the condition of the photoconductor when no image defect is detected.

9. The image forming apparatus according to claim 8, further comprising an output tray on which image forming media after image formation are stacked,
wherein the reader is disposed between the photoconductor and the output tray.

10. An image forming system comprising:
the image forming apparatus according to claim 1; and
an information processing apparatus including:
a memory that stores the machine learning model; and
processing circuitry, wherein
the circuitry of the image forming apparatus is configured to transmit a detection result of the charging current to the information processing apparatus via a network,
the processing circuitry of the information processing apparatus is configured to input the detection result of the charging current to the machine learning model to obtain the determination result of the condition, and
the circuitry of the image forming apparatus is configured to receive the determination result of the condition from the information processing apparatus.

11. An abnormality detection method comprising:
detecting a charging current that flows when a photoconductor is charged; and
determining a condition of the photoconductor using a machine learning model having learned a relationship between the charging current and the condition of the photoconductor.

12. A non-transitory recording medium storing a plurality of program codes which, when executed by one or more processors, causes the one or more processors to perform a method, the method comprising:
detecting a charging current that flows when a photoconductor is charged; and
determining a condition of the photoconductor using a machine learning model having learned a relationship between the charging current and the condition of the photoconductor.
